(19) United States
(12) Patent Application Publication
(10) Pub. No.: US 2013/0031219 A1
(43) Pub. Date: Jan. 31, 2013

(54) Device And Method For Downloading Movie File

(71) Applicant: Jun LIU, Shenzhen City (CN)

(72) Inventor: Jun LIU, Shenzhen City (CN)

(73) Assignee: TENCENT TECHNOLOGY (SHENZHEN) COMPANY LIMITED, Shenzhen City (CN)

(21) Appl. No.: 13/610,255

(22) Filed: Sep. 11, 2012

Related U.S. Application Data
(63) Continuation of application No. PCT/CN2011/071747, filed on Mar. 11, 2011.

(30) Foreign Application Priority Data
Mar. 15, 2010 (CN) 201010126062.9

(51) Int. Cl. G06F 15/16

(52) U.S. Cl. 709/219

(57) ABSTRACT

A device and method for downloading a movie file. The device includes a file parsing module, a file segmenting module, a network downloading module and a preview playing module. The file segmenting module segments a movie file according to position information of key frames parsed by the file parsing module. The network downloading module downloads file data according to file segmenting information, and the preview playing module implements a rapidly preview of movie content using downloaded file data.

### CROSS-REFERENCE TO RELATED APPLICATIONS

This application is a continuation of International Application No. PCT/CN2011/071747, filed on Mar. 11, 2011. This application claims the benefit and priority of Chinese Patent Application No. 201010126062.9, filed Mar. 15, 2012. The entire disclosures of each of the above applications are incorporated herein by reference.

### FIELD

The present disclosure relates to movie file processing technologies and to a device and method for downloading a movie file.

### BACKGROUND

This section provides background information related to the present disclosure which is not necessarily prior art.

With the development of broadband Internet, network video resources provided by the Internet are becoming richer. It has become very popular to download movies from the Internet. At present, there are many kinds of downloading software capable of meeting the users' demand for downloading movie files.

Protocols supported by general downloading software includes Hypertext Transfer Protocol (HTTP), File Transfer Protocol (FTP), Bit Comet (BT) downloading protocol, eDonkey2000 network (ED2K) (eMule) protocol, Multimedia Message (MMS) protocol, Real Time Streaming Protocol (RTSP), and so on. The different downloading protocols have different downloading features. HTTP and FTP are conventional file transfer protocols, based on the Client/Server architecture, where a client downloading software pulls file content to be downloaded in turn from a server. BT and ED2K (eMule) protocol are new Peer-to-Peer (P2P) protocols. The P2P protocol is also called Peer to Peer Internet technique, which is different from the conventional Client/Server architecture, where clients participating in the downloading constitute a node network in the P2P technique, and one client may obtain file data to be downloaded from any other client in the network rather than completely depend on the server. MMS and RTSP are streaming media transfer protocols, which are used to transfer real-time media stream, such as Windows Media, published by a streaming media server.

As can be seen from the above-mentioned protocol classifications, except for MMS and RTSP which are protocols developed specifically for network media, all other protocols, when downloading a movie file, are approaching the movie file as an ordinary file. FIG. 1 is a schematic diagram illustrating system architecture of existing general downloading software. As shown in FIG. 1, a network downloading module downloads file data to a local file according to file segmenting information provided by a file segmenting module. The existing downloading software performs no specific processing on the movie file. Instead, the existing downloading software equally segments the movie file (for instance, each 512 KB is taken as a basic unit) as segmenting an ordinary file. In order to improve downloading efficiency, a downloading client may simultaneously download data segments of different positions from multiple nodes in a node network. However, this downloading mechanism will result in file positions of downloaded data segments which are not consecutive, and according to video encoding theory, non-consecutive data blocks are unable to be played. Therefore, it is usually necessary for conventional downloading software to completely download a movie before the movie can be played. Thus it is necessary for a user to wait for a long time, and the user cannot determine in advance whether the movie content meets the user's demand, and cannot preview highlights of the movie ahead of time.

In the existing file segmenting method, video data of each frame in the movie is usually segmented into two units, and it cannot be located where the position of the key frame starts. Therefore, it is difficult to decode a movie file without being completely downloaded into complete video frames, and then a preview function of the movie file cannot be achieved. A user must preview the movie file in turn or watch the movie file after the movie file is completely downloaded, which results in a long wait time; or the movie completely downloaded cannot satisfy the user's demand, which results in a waste of downloading time.

### SUMMARY

This section provides a general summary of the disclosure, and is not a comprehensive disclosure of its full scope or all of its features.

In view of above, various embodiments provide a device for downloading a movie file and a method for downloading a movie file, which can achieve a quick preview of the movie content, and avoid wasting of downloading time.

The device for downloading a movie file provided by various embodiments includes: a file parsing module, a file segmenting module, a network downloading module and a preview playing module; in which,
the file parsing module is to obtain position information of key frames of a movie file to be downloaded;
the file segmenting module is to segment the movie file according to the position information of key frames came from the file parsing module;
the network downloading module connected with a downloading server or a downloading node through a network connection, is to download movie file data according to file segmenting information came from the file segmenting module;
the preview playing module is to implement the preview playing using the movie file data downloaded by the network downloading module.

The file parsing module, according to a type of a movie file to be downloaded, sends a first instruction to the network downloading module, and receives characteristic data from the network downloading module; obtains position information of key frames of the movie file to be downloaded from the characteristic data, and outputs the position information of key frames to the file segmenting module; and sends a second instruction to the network downloading module;
the file segmenting module receives the position information of key frames sent from the file parsing module, segments the movie file according to the position information of key frames, and outputs file segmenting information to the network downloading module;
the network downloading module, after receiving the first instruction, downloads characteristic data of a file header and a file tail of the movie file; after receiving the second instruction, downloads movie file data according to the file segmenting information sent from the file segmenting module;

The preview playing module further, according to a position of movie file data being played, sends a third instruction to the network downloading module.

The network downloading module further downloads movie file data to be played according to the third instruction from the preview playing module.

The network downloading module further stores the downloaded movie file data into a local file.

The network downloading module adopts Peer-to-Peer, P2P, downloading mode, serially downloading mode or preview downloading mode.

The preview playing module serially plays images of key frames in downloaded movie file data.

The preview playing module further serially plays the movie file utilizing downloaded movie file data.

The method for downloading a movie file provided by various embodiments includes:
obtaining position information of key frames of a movie file to be downloaded;
segmenting the movie file according to the position information of key frames;
downloading movie file data according to file segmenting information, and
utilizing downloaded movie file data to implement the preview playing.

The obtaining position information of key frames of a movie file to be downloaded includes:
according to a type of the movie file to be downloaded, downloading characteristic data of a file header and a file tail of the movie file; and
obtaining position information of key frames of the movie file to be downloaded from the characteristic data.

The method further includes downloading movie file data to be played according to a position of movie file data being played.

The method further includes serially playing images of key frames in downloaded movie file data.

The method further includes serially playing the movie file utilizing downloaded movie file data.

As can be seen from the above technical solutions provided by various embodiments, the disclosure includes a file parsing module, a file segmenting module, a network downloading module and a preview playing module. The file segmenting module segments a movie file according to position information of key frames parsed by the file parsing module; the network downloading module downloads file data according to file segmenting information; and the preview playing module implements a rapid preview of movie content using downloaded file data. The disclosure provided by various embodiments helps users to quickly know the outline of the movie, achieves the purpose for previewing content segments in which a user is interested in advance, and avoids a waste of downloading time.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating system architecture of existing general downloading software;

FIG. 2 is a schematic diagram illustrating a structure of a device for downloading a movie file;

FIG. 3 is a flowchart illustrating a method for downloading a movie file;

FIG. 4 is a schematic diagram illustrating a structure of a RMVB file.

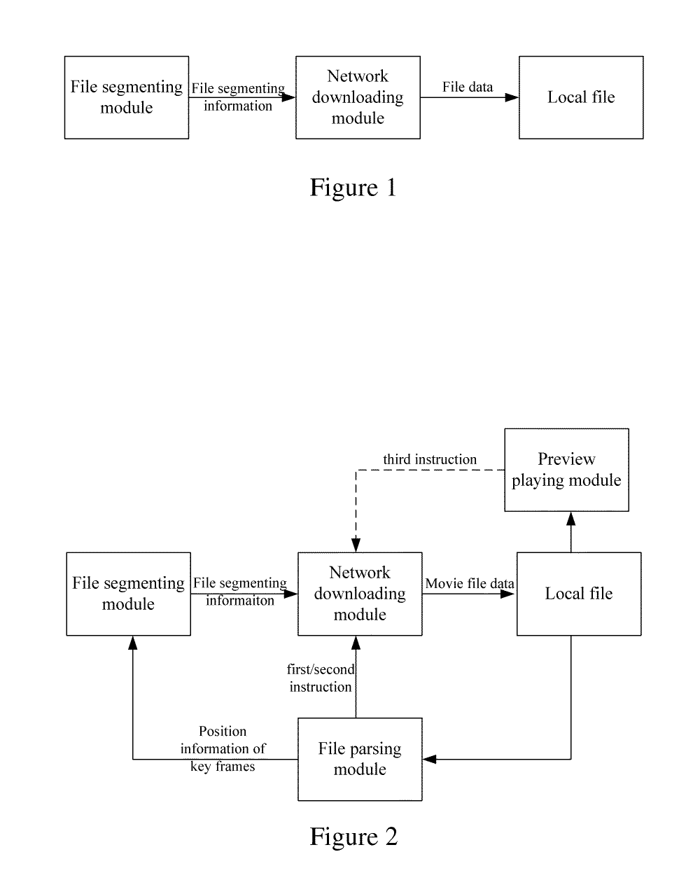

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In general, there are two types of video encoding frames, namely, I-frame and P-frame. I-frame is also called intra-frame reference frame or key frame. When an I-frame is encoded, only information in the image frame is referred to, so the I-frame may be independently decoded. P-frame is also called forward reference frame. When a P-frame is encoded, information of previous frame is referred to, so when the P-frame is decoded, data of a previous frame is needed. When a movie file is encoded, a key frame, that is, an I-frame is inserted in P-frames at an interval of several seconds. Thus the decoding and playing may be started from the key frames, and then forward reference frames may be decoded in turn.

Since key frames may be independently decoded, data of the key frames is relatively more important in movie file data. In general, positions of key frames in a movie file will be recorded in structure descriptions of the movie file. Various embodiments segment the movie file utilizing position information of the key frames, and download file data according to file segmenting information, rapidly previews movie content using downloaded file data, which helps users quickly know the outline of the movie, and preview content segments in which a user is interested in advance. There exits data of a key frame at each time interval of a movie file. Supposing that the time interval is T, the average data size of a key frame is N times of that of a non-key frame, and the movie frame rate is F, the ratio of key frame data to non-key frame data in a movie file is N:(T*F−1), in which, * denotes multiplication. An example is provided in which the time interval of key frame data is 10 seconds, the frame rate is 25 frames per second, and the data size of a key frame is 5 times of that of a non-key frame, then the ratio of key frame data to non-key frame data is 1:50 based on empirical data. Namely, it is possible to extract key frame data which is about 2 percent of data of the movie file to achieve quick sampling of the movie content. Sampled key frame data may be used to achieve the preview playing of various embodiments, and help users know the outline of the movie.

FIG. 2 is a schematic diagram illustrating a structure of a device for downloading a movie file. As shown in FIG. 2, the device includes a file parsing module, a file segmenting module, a network downloading module, and a preview playing module.

The file parsing module is configured to, according to the type of movie file to be downloaded, send a first instruction to the network downloading module for instructing the network downloading module to download characteristic data of the file header and the file tail, obtain position information of key frames of the movie file to be downloaded from the characteristic data, and output the position information of key frames to the file segmenting module; and send a second instruction to the network downloading module.

The file segmenting module is configured to receive the position information of key frames from the file parsing module, segment the movie file according to the received position information of key frames, and output file segmenting information to the network downloading module.

The network downloading module communicates with a downloading server or a downloading node through a network connection. After receiving the first instruction, the networking downloading module downloads characteristic data of the file header and the file tail of the movie file. After receiving the second instruction, the networking downloading module downloads movie file data according to the file segmenting information that came from the file segmenting module. The network downloading module is further configured to store downloaded movie file data in a local file.

The preview playing module is configured to implement the preview playing using the downloaded movie file data. The preview playing module is further configured to, according to the position of data being played, send a third instruction to the network downloading module for instructing the network downloading module to first download the data to be played. Correspondingly, the network downloading module is further configured to download file data according to the third instruction that came from the preview playing module.

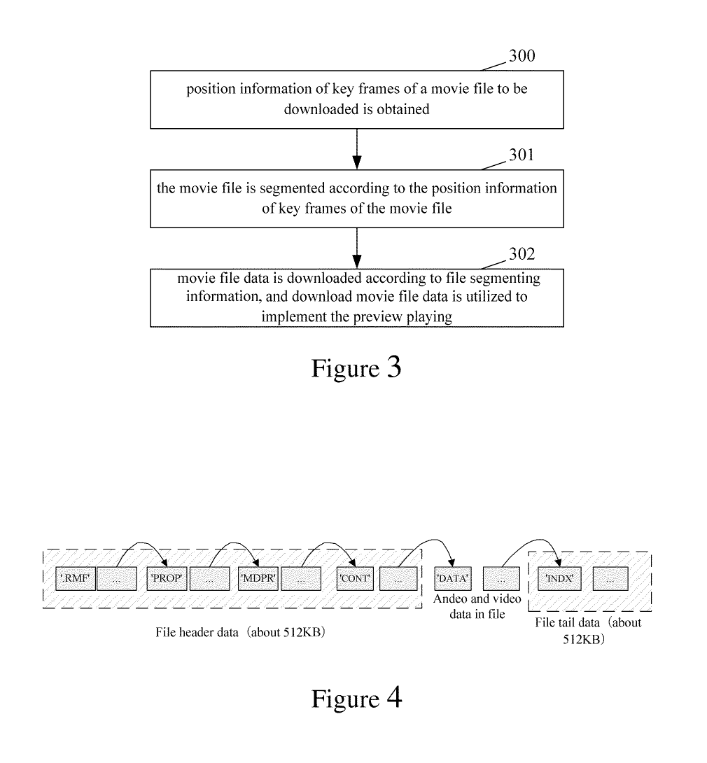

FIG. 3 is a flowchart illustrating a method for downloading a movie file. As shown in FIG. 3, the method includes the following processes.

Block 300, position information of key frames of a movie file to be downloaded is obtained.

The block includes: characteristic data of a file header and a file tail of the movie file is downloaded according to the type of the movie file, and position information of key frames of the movie file to be downloaded is obtained from the characteristic data.

Block 301, the movie file is segmented according to the position information of key frames of the movie file.

Block 302, movie file data is downloaded according to file segmenting information, and downloaded movie file data is utilized to implement the preview playing.

Furthermore, the method of the embodiment further includes: file data is downloaded according to the position of data being played.

Because structures of files with different movie file formats are different, the device for downloading a movie file shown in FIG. 2 and the method for downloading a movie file shown in FIG. 3 will be described in detail hereinafter with reference to concrete examples. A file of RMVB video file format is taken as an example.

Movie downloading is started. A general movie file consists of three parts: description information in the file header (denoted by HEAD), audio and video data in the file (denoted by DATA), and index data in the file tail (denoted by INDX). The size of description information in the file header and the index data in the file tail are usually smaller. For example, the size of file header data or file tail data of a RMVB file is about 512 KB. The file parsing module sends the first instruction to the network downloading module, the network downloading module first downloads the file header data and the file tail data. The sizes of file header data and file tail data of different movie files are different, as shown in table 1. Therefore, the size of file header data and file tail data to be downloaded may be determined based on the experience.

TABLE 1

| | RMVB format | AVI format | FLV format | . . . |
|---|---|---|---|---|
| Size of HEAD | 512 KB | 2 MB | 512 KB | |
| Size of INDX | 512 KB | 16 MB | 0 KB | |

As shown in table 1, the RMVB format is taken for an example, and the file parsing module will instruct the network downloading module to first download 512 KB data of the file header and 512 KB INDX data of the file tail.

The file parsing module will parse out position information of key frames. For most of movie file container formats, position information of key frames will be recorded in INDX data of the file tail. Therefore, for a movie file including INDX data, the file parsing module will parse out position information of key frames. The RMVB is taken for an example, and the parsing process is depicted in FIG. 4.

FIG. 4 is a schematic diagram illustrating a structure of a RMVB file. As shown in FIG. 4, description information of a file is parsed out according to keywords ‘RMF’, ‘PROP’, ‘MDPR’ and ‘CONT’ (‘RMF’ denotes that the file is a file of Real format, ‘PROP’ denotes an attribute of the file, ‘MDPR’ denotes an attribute of media streams, ‘CONT’ denotes file content description) in the file header. The description information of the file may include playing time of the file, number of audio and video streams, type of audio and video encoding, audio and video bit rate, and the like. The specific information may refer to relevant disclosed documents, which can be easily obtained by one skilled in the art, and no further descriptions will be provided.

The INDX data block in the file tail is parsed. Main information of the INDX data block consists of multiple index records, each index record may be denoted by the following structure:

struct {UINT32 tStart, ptrFilePos, packet;} IndexRecord;

Each index record corresponds to position information of a key frame. In the above structure, ptrFilePos denotes an absolute position of the key frame in the file, tStart denotes file time corresponding to the key frame, and packet denotes the number of data packets between the key frame and next key frame.

The file parsing module outputs an obtained index record list to the file segmenting module. The file segmenting module segments the movie file into file blocks according to positions of key frames, rather than segmenting the movie file into file blocks equally (for instance, the size of each file block is 512 KB) as the existing general downloader does. In various embodiments, the advantage of segmenting the file according to position information of key frames can include the following. Each basic unit may be played independently. There are multiple existing specific methods for segmenting a file in the art, and no further descriptions will be provided here. Various embodiments emphasize that the file segmenting module segments a movie file according to positions of key frames.

The file segmenting module sends file segmenting information to the network downloading module, and the network downloading module downloads corresponding data segments according to the file segmenting information. The network downloading module may adopt three downloading modes, that is, Peer-to-Peer (P2P) downloading mode, serially downloading mode and preview downloading mode.

In the P2P downloading mode, data segments of different positions may be simultaneously downloaded from multiple downloading nodes. Since the data segments of different positions are segmented according to positions of key frames, a video decoder may decode the data segments, and each data segment may be played independently. The downloaded data segments may be played before the movie file has been completely downloaded, and it is not necessary for a user to wait for a long time to determine whether the content of the movie file meets the user's needs ahead of time.

In the serially downloading mode, data segments are downloaded from start to finish in time sequence.

In the preview downloading mode, image data of the first frame of each data segment is firstly downloaded. Based on experience, data of the key frames, namely, the first frame of each data segment, are only about 2% of the movie file, so in the preview downloading mode, by downloading data of key frames, the quick downloading of a movie file is achieved, and highlights of the movie file may be previewed in advance.

After the data of key frames is downloaded, the preview playing module may start the preview playing. The preview playing module may first provide a story slideshow function. With the story slideshow function, key frames images in downloaded movie file data may be serially played at a certain interval. Because the key frame images are evenly distributed in the complete file range, the story slides may allow a user to quickly know the summary of the whole movie. The story slideshow function is a conventional technique to one skilled in the art, and the specific implementation is not used to limit the scope of protection. It is emphasized in various embodiments that the downloaded key frame images are serially played at a certain interval.

The preview playing module further provides a highlight preview function and a playing while downloading function. When the story slides are played to a scene in which the user is interested, the user may click a playing button to watch segments from the position corresponding to the scene in the file. The preview playing module will send the third instruction to the network downloading module for instructing the network downloading module to first download data segments to be played. With the playing while downloading function, the data segments to be played may be serially downloaded from the beginning of the file. Then the preview playing module may completely play the movie utilizing the data segments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device for downloading a movie file, comprising: a file parsing module, a file segmenting module, a network downloading module and a preview playing module; wherein,
the file parsing module is to obtain position information of key frames of a movie file to be downloaded;
the file segmenting module is to segment the movie file according to the position information of key frames came from the file parsing module;
the network downloading module connected with a downloading server or a downloading node through a network connection, is to download movie file data according to file segmenting information came from the file segmenting module;
the preview playing module is to implement the preview playing using the movie file data downloaded by the network downloading module.

2. The device according to claim 1, wherein the file parsing module is to, according to a type of a movie file to be downloaded, send a first instruction to the network downloading module, and receive characteristic data came from the network downloading module; obtain position information of key frames of the movie file to be downloaded from the characteristic data, and output the position information of key frames to the file segmenting module; and send a second instruction to the network downloading module;
wherein the file segmenting module is to receive the position information of key frames sent from the file parsing module, segment the movie file according to the position information of key frames, and output file segmenting information to the network downloading module;
wherein the network downloading module is to, after receiving the first instruction, download characteristic data of a file header and a file tail of the movie file; after receiving the second instruction, download movie file data according to the file segmenting information sent from the file segmenting module.

3. The device according to claim 2, wherein the preview playing module is further configured to, according to a position of movie file data being played, send a third instruction to the network downloading module;
wherein the network downloading module is further to download movie file data to be played according to the third instruction came from the preview playing module.

4. The device according to claim 2, wherein the network downloading module is further to store the downloaded movie file data into a local file.

5. The device according to claim 4, wherein the network downloading module adopts Peer-to-Peer, P2P, downloading mode, serially downloading mode or preview downloading mode.

6. The device according to claim 2, wherein the preview playing module serially plays images of key frames in downloaded movie file data.

7. The device according to claim 2, wherein the preview playing module is further to serially play the movie file utilizing downloaded movie file data.

8. A method for downloading a movie file, comprising:
obtaining position information of key frames of a movie file to be downloaded;
segmenting the movie file according to the position information of key frames;
downloading movie file data according to file segmenting information, and
utilizing downloaded movie file data to implement the preview playing.

9. The method according to claim 8, wherein obtaining position information of key frames of a movie file to be downloaded comprises:
according to a type of the movie file to be downloaded, downloading characteristic data of a file header and a file tail of the movie file;
obtaining position information of key frames of the movie file to be downloaded from the characteristic data.

10. The method according to claim 8, further comprising:
downloading movie file data to be played according to a position of movie file data being played.

11. The method according to claim 8, further comprising:
serially playing images of key frames in downloaded movie file data.

12. The method according to claim 8, further comprising:
serially playing the movie file utilizing downloaded movie file data.
